(19) United States
(12) Patent Application Publication
(10) Pub. No.: US 2018/0201712 A1
(43) Pub. Date: Jul. 19, 2018

(54) HOT-MELT ADHESIVE, CONTAINING POLY(METH) ACRYLATE MADE FROM ALKYL(METH)ACRYLATES AND FROM DETERMINED HETEROCYCLIC GROUPS CONTAINING (METH)ACRYLATES

(71) Applicant: BASF SE, Ludwigshafen (DE)

(72) Inventors: Ulrike LICHT, Mannheim (DE); Dirk WULFF, Schifferstadt (DE); Andrea MISSKE, Speyer (DE)

(73) Assignee: BASF SE, Ludwigshafen (DE)

(21) Appl. No.: 15/741,817

(22) PCT Filed: Jul. 14, 2016
(86) PCT No.: PCT/EP2016/066707

§ 371 Date: Jan. 4, 2018

(30) Foreign Application Priority Data
Jul. 16, 2015 (EP) 15177088.0

(51) Int. Cl. C08F 220/18; C09J 133/06

(52) U.S. Cl. CPC C08F 220/18; C09J 133/064; C09J 2205/31; C08F 2220/1858; C08F 2220/1825

(57) ABSTRACT

Described is a hotmelt adhesive comprising at least one poly(meth)acrylate which is formed from at least one monomer M1, selected from C1 to C18 alkyl (meth)acrylates, and from at least one monomer MI of the general formula

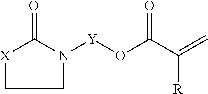

where X is O, NH or CH₂, Y is a divalent organic connecting group, and R is H or methyl. Also described is a corresponding poly(meth)acrylate with copolymerized photoinitiator, and also the use for the production of adhesives, preferably of pressure-sensitive adhesives for producing adhesive labels, adhesive tapes, plasters, bandages, and self-adhesive sheets.

The invention relates to a pressure-sensitive adhesive, more particularly in the form of a hotmelt adhesive, comprising at least one poly(meth)acrylate which is formed from C1 to C18 alkyl (meth)acrylates and from defined (meth)acrylates comprising heterocyclic groups. The invention also relates to a corresponding poly(meth)acrylate with copolymerized photoinitiator, and also to the use for the production of adhesives, preferably of pressure-sensitive adhesives for producing pressure-sensitive adhesive products.

With acrylate-based pressure-sensitive adhesives the desire is for a balanced tradeoff between adhesion behavior (adhesion to the substrate) and cohesion, behavior (internal strength within the layer of adhesive). Accordingly there ought for example to be effective adhesion to steel surfaces, an assurance of effective flow onto the substrate surface, and at the same time a high level of cohesion at room temperature and at elevated temperatures, such as at 70° C. For ease of application, a boundary condition complied with at the same time ought to be an extremely low melt viscosity (in the case of hotmelt adhesives, e.g., so-called 100% UV hotmelts) and an extremely low dispersion viscosity at high solids content (in the case of aqueous pressure-sensitive adhesive dispersions).

Radiation-crosslinkable hotmelt adhesives based on (meth)acrylate polymers and their use as pressure-sensitive adhesives (PSAs) are known from DE 102004058070, EP-A 246 848, EP-A 377 191, EP-A 445 641, or WO 01/23488, for example, Aqueous PSA dispersions and polymer dispersions for cold sealing, containing acrylate polymers formed from monomers including defined (meth)acrylate monomers containing heterocyclic substituents, are known from WO 2012/139941, WO 20121140174, and WO 2014/154507.

The object of the invention was to provide polymers for PSAs, endowed with enhanced cohesion effect in conjunction with effective adhesion, with good flow-on behavior, and with extremely low application viscosity,

The object is achieved in accordance with the invention by a hotmelt adhesive comprising at least one poly(meth)acrylate which is formed from

(a) at least one monomer M1 selected from C1 to C18 alkyl (meth)acrylates, and

(b) at least one monomer M2 of the general formula

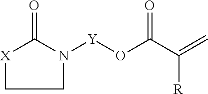

where X is O, NH or CH₂,
Y is a divalent organic connecting group, preferably a substituted or unsubstituted, linear or branched chain having 2 to 12 C atoms, which may be interrupted by 0, N, or S atoms, and
R is H or methyl,

and optionally further monomers different from the monomers M1 and M2.

The invention also provides a poly(meth)acrylate suitable for use as or in a hotmelt adhesive, where the poly(meth)acrylate is formed from

(a) at least one monomer M1 selected from C1 to C18 alkyl (meth)acrylates and

(b) at least one monomer M2 of the general formula

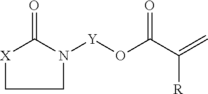

where X is O, NH or CH₂,

Y is a divalent organic connecting group, preferably a substituted or unsubstituted, linear or branched chain having 2 to 12 C atoms, which may be interrupted by O, N, or S atoms, and

R is H or methyl,

and at least one photoinitiator copolymerized into the poly(meth)acrylate.

The poly(meth)acrylate is preferably formed from

(a) the monomers M1 to an extent of at least 50 wt %, based on the sum of all the monomers, and

(b) the monomers M2 to an extent of at least 0.1 wt %, based on the sum of all the monomers.

The poly(meth)acrylate preferably has a glass transition temperature of less than or equal to 10° C., more particularly of −60 to +10° C.

The glass transition temperature determined by differential scanning calorimetry (ASTM D 3418-08, midpoint temperature). The glass transition temperature of the polymer is the glass transition temperature obtained on evaluation of the second heating curve (heating rate 20° C./min). In the case of (radiation-)crosslinkable polymers, the glass transition temperature refers to that of the noncrosslinked polymer.

The adhesive is preferably a pressure-sensitive adhesive (PSA). A PSA is a viscoelastic adhesive whose set film at room temperature is permanently tacky, and remains adhesive, in the dry state at room temperature (20° C.). Bonding to substrates is accomplished instantaneously by gentle applied pressure.

The hotmelt adhesive may be radiation-crosslinkable, preferably UV-crosslinkable. The term “radiation-crosslinkable” means that the hotmelt adhesive comprises at least one compound having at least one radiation-sensitive group and on irradiation a crosslinking reaction is induced. The irradiation for the crosslinking takes place preferably with actinic radiation, preferably UV light, more particularly UV-C radiation. A radiation-crosslinkable hotmelt adhesive preferably comprises at least one photoinitiator. The photoinitiator may be present in the form of an additive not bonded to the poly(meth)acrylate, and/or the photoinitiator may have been copolymerized into the poly(meth)acrylate.

Hotmelt adhesives, which are also known as hotmelts or hot glues, are solvent-free products (i.e., not in solution or dispersion in water or organic solvents) which are more or less solid at room temperature, but in the hot state are sufficiently fluid and, on account of the associated reduction in viscosity, can be applied to a bonding surface, and on cooling they produce the adhesive bond; radiation-crosslinkable hotmelt adhesives may additionally be irradiated.

In the text below, occasionally the term “(meth)acryl . . . ” and similar terms are used as an abbreviated notation for “acryl . . . or methacryl . . . ”. In the designation Cx alkyl (meth)acrylate and analogous designations, x denotes the number of C atoms in the alkyl group.

Unless explicitly indicated otherwise, quantity figures for monomers of a polymer are based on 100 parts by weight of the sum of all the monomers.

The (preferably radiation-crosslinkable) poly(meth)acrylate is formed to an extent of at least 50 wt % or at least 60 wt %, or at least 80 wt %, of C1 to C18 alkyl (meth)acrylates monomers M1). Preference is given to C1 to C10 alkyl (meth)acrylates, or C4 to C10 alkyl (meth)acrylates, or C1-C8 alkyl (meth)acrylates, especially C4 to C8 alkyl (meth)acrylates, e.g., methyl (meth)acrylate, ethyl acrylate, n-butyl acrylate, n-hexyl acrylate, 2-propylhexyl acrylate, and 2-ethylhexyl acrylate, and mixtures thereof. Particularly preferred are n-butyl acrylate and 2-ethylhexyl acrylate.

In one embodiment of the invention, the poly(meth)acrylate polymer consists to an extent of at least 80 wt % of at least one acrylate which is selected from the group consisting of n-butyl acrylate, n-hexyl acrylate, 2-ethylhexyl acrylate, 2-propylhexyl acrylate, and mixtures thereof, or the poly(meth)acrylate polymer consists to an extent of at least 90 wt % of 2-ethylhexyl acrylate or n-butyl acrylate.

The (preferably radiation-crosslinkable) poly(meth)acrylate is synthesized preferably to an extent of at least 0.1 wt %, at least 0.2 wt %, at least 1 wt %, or at least 5 wt %, and preferably up to 30 wt % or up to 25 wt %, of the monomers M2. In the case of hotmelt adhesives the poly(meth)acrylate is synthesized preferably to an extent of 1 to 30 wt % or of 5 to 25 wt % of the monomers M2. In the case of aqueous dispersion adhesives, the poly(meth)acrylate is synthesized preferably to an extent of 0.1 to 5 wt % or 0.2 to 2 wt % of the monomers M2.

The monomer M2 has the general formula

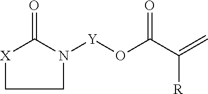

where X is O, NH, or CH₂,

Y is a bivalent organic connecting group, preferably a substituted or unsubstituted, linear or branched chain having 2 to 12 C atoms, and may be interrupted by O, N, or S atoms, and

R is H or methyl.

Preferably Y is a linear or branched alkylene group having 2 to 12 C atoms or having 2 to 6 C atoms, as for example a linear alkylene group having 2 to 6 C atoms, e.g., ethylene, propylene, butylene, pentylene, or hexylene. Particularly preferred are monomers of the following formulae:

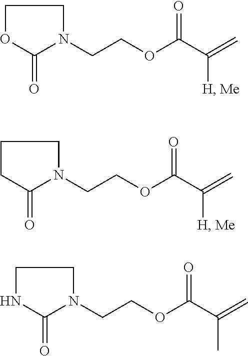

Particularly preferred are 2-(2-oxooxazolidin-3-yl)ethyl acrylate, 2-(2-oxopyrrolidin-yl)ethyl acrylate, 2-(2-oxoimidazolidin-1-yl)ethyl acrylate, 2-(2-oxooxazolidin-3-yl)ethyl methacrylate, 2-(2-oxopyrrolidin-1-yl)ethyl methacrylate, and 2-(2-oxoimidazolidin-1-yl)ethyl methacrylate, or mixtures of these monomers.

The poly(meth)acrylate polymer may be formed from further, ethylenically unsaturated compounds as synthesis components, examples being vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and 1 or 2 double bonds, or mixtures of these monomers. Vinyl esters of carboxylic acids having 1 to 20 C atoms are, for example, vinyl laurate, vinyl stearate, vinyl propionate, Versatic acid vinyl esters, and vinyl acetate. Vinylaromatic compounds contemplated include, for example, vinyltoluene, α- and p-methylstyrene, alpha-butylstyrene, 4-n-butylstyrene, 4-n-decylstyrene, and, preferably, styrene. Examples of nitriles are acrylonitrile and methacrylonitrile. The vinyl halides are ethylenically unsaturated compounds substituted by chlorine, fluorine or bromine, preferably vinyl chloride and vinylidene chloride. Vinyl ethers include, for example, vinyl methyl ether or vinyl isobutyl ether. Preference is given to vinyl ethers of alcohols comprising 1 to 4 C atoms. Hydrocarbons having 2 to 8 C atoms and two olefinic double bonds include butadiene, isoprene, and chloroprene.

The poly(meth)acrylate polymer may be formed, in addition to the monomers M1 and M2, preferably from at least one monomer having polar groups. Monomers having polar groups are, for example, monomers in which the polar groups are selected from carboxylic acid, groups, carboxylic anhydride groups, hydroxyl groups, amide groups, urethane groups, urea groups, piperidyl groups, piperazinyl groups, morpholinyl groups, imidazolyl groups, and combinations of two or more of said groups.

The monomers having polar groups preferably have a water solubility at 21° C. of more than 5 g/liter or more than 10 g/liter. The poly(meth)acrylate polymer is preferably formed to an extent of 0.1 to 30 wt %, more preferably of 0.3% to 25 wt %, or of 0.5 to 15 wt % or of greater than or equal to 1 to 15 wt %, of the monomers having polar groups.

Further monomers contemplated include more particularly mono having carboxylic, sulfonic or phosphonic acid groups. Carboxylic acid groups are preferred Examples include acrylic acid, methacrylic acid, itaconic acid, maleic acid or fumaric acid. Preferred monomers with carboxylic acid groups are acrylic acid and methacrylic acid.

Further monomers are, for example, also (meth)acrylamide and monomers comprising hydroxyl groups, more particularly C1-C10 hydroxyalkyl (meth)acrylates. Preferred monomers with hydroxyl groups are C1-C10 hydroxyalkyl (meth)acrylates, especially hydroxyethyl (meth)acrylate and hydroxypropyl (meth)acrylate. Mention may further be made of phenyloxyethylglycol mono(meth)acrylate, glycidyl acrylate, glycidyl methacrylate, amino(meth)acrylates such as 2-aminoethyl(meth)acrylate. Monomers which as well as the double bond also carry further functional groups, e.g., isocyanate-, amino-, hydroxyl-, amide- or glycidyl-, may have the effect, for example, of improving the adhesion to substrates.

In one embodiment the hotmelt adhesive or the poly(meth)acrylate is radiation-crosslinkable, by irradiation with UV light, for example. In that case the hotmelt adhesive comprises at least one photoinitiator. This photoinitiator may be present exclusively as an additive not bonded to the poly(meth)acrylate. In another embodiment, the photoinitiator is present exclusively as a component copolymerized into the poly(meth)acrylate. Also possible, however, is a combination of these two embodiments. Radiation-crosslinkable poly(meth)acrylates have a glass transition temperature prior to crosslinking of preferably less than or equal to 10° C. e.g., from −60 to +10° C.

For radiation crosslinking, the hotmelt adhesive comprises a photoinitiator. The photoinitiator is preferably copolymerized in the poly(meth)acrylate. It may also, however, be unbonded and merely mixed with the polymer. Examples of typical photoinitiators that may be added as an additive to the polymer include acetophenone, benzoin ethers, benzil dialkyl ketals or derivatives thereof. The amount of the admixed photoinitiator is preferably 0.05 to 10 parts by weight, more preferably 0.1 to 2 parts by weight, per 100 parts by weight of poly(meth)acrylate.

Through irradiation with high-energy light, more particularly UV tight, the photoinitiator or photoinitiator group brings about crosslinking of the polymer and/or oligomer, preferably by means of a chemical grafting reaction of the photoinitiator group with a spatially adjacent polymer or oligomer chain. Crosslinking may be accomplished in particular by insertion of a carbonyl group of the photoinitiator into an adjacent C—H bond, with formation of a —C—C—O—H moiety. The wavelength range within which the photoinitiator group can be activated, i.e., in which the principal absorption band of the photoinitiator group is situated, is preferably 200 to 450 nm, more preferably 250 to 350 nm, very preferably 250 to 280 nm.

The hotmelt adhesive comprises preferably 0.0001 to 0.1 mol, more preferably 0.0002 to 0.1, very preferably 0.0003 to 0.01 mol of the photoinitiator, or of the molecular group that acts as a photoinitiator and is bonded to the polymer, per 100 g of hotmelt adhesive.

The radiation-crosslinkable poly(meth)acrylate may be an adhesive based on a polymer with copolymerized photoinitiator. The poly(meth)acrylate may be prepared by radical polymerization of ethylenically unsaturated monomers, with copolymerization of at least one radiation-sensitive, radically polymerizable organic compound. Radiation-sensitive, radically polymerizable organic compounds are identified for short below as polymerize a photoinitiator. The polymerizable photoinitiator may be installed in the polymer chain of copolymers by means of radical copolymerization. Polymerizable photoinitiators preferably have the following fundamental construction:

A-X—B

where A is a monovalent organic radical having preferably a phenone group as radiation-sensitive group,

X is an ester group selected from —O—C(═O)—, —(C═O)—O—, and —O—(C═O)—O—, and

B is a monovalent organic radical which comprises an ethylenically unsaturated, radically polymerizable group. Preferred radicals A are radicals which comprise at least one structural element derived from phenones, more particularly from acetophenones or benzophenones. Preferred radicals B comprise at least one, preferably precisely one, acrylic or methacrylic group.

The ethylenically unsaturated group may be bonded directly to the group X. The radiation-sensitive group may also be bonded directly to the group X. Alternatively there may be a spacer group located in each case between ethylenically unsaturated group and the group X or between radiation-sensitive group and group X. The spacer group may have; for example, a molecular weight of up to 500, more particularly up to 300 or 200 g/mol.

Suitable photoinitiators are, for example, compounds with acetophenone or benzophenone structural units, described for example in EP 377191 A or EP 1213306 A. One preferred group X is the carbonate group —O—(C═O)—O—. Preferred polymerizable photoinitiators are compounds of the formula F-1:

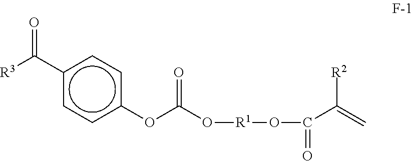

in which R1 is an organic radical having up to 30 C atoms, R2 is an H atom or a methyl group, and R3 is a substituted or unsubstituted phenyl group or is a C1-C4 alkyl group. R1 more preferably is an alkylene group, more particularly a C2-C8 alkylene, group. R3 more preferably is a methyl group or is a phenyl group, very preferably a phenyl group.

Further acetophenone and benzophenone derivatives suitable as copolymerizable photoinitiators are, for example, those of the formula F-2

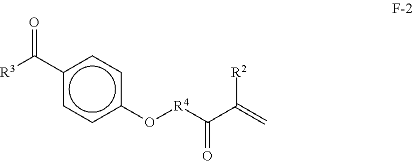

in which R2 and R3 can have the definition above and R4 can be a single bond or (—CH2-CH2-O)n, where n is an integer from 1 to 12.

In the case of the copolymerized photoinitiator, the poly(meth)acrylate is formed preferably to an extent of 0.05% to 10% by weight or 0.05% to 5% by weight, more preferably 0.1% to 2% by weight or 0.1% to 1% by weight, of at least one ethylenically unsaturated copolymerizable compound having a photoinitiator group.

A poly(meth)acrylate preferred in accordance with the invention is formed from
(a1) at least 60 wt % of at least one monomer M1 which is selected from the group consisting of n-butyl acrylate, n-hexyl acrylate, 2-ethylhexyl acrylate, propylheptyl acrylate, and mixtures thereof, and
(a2) 0.5 to 15 wt % of monomers having polar groups, the polar groups being selected from carboxylic acid groups,
(b) 0.2 to 25 of monomers M2 selected from 2-(2-oxooxazolidin-3-yl)ethyl (meth)acrylate, 2-(2-oxopyrrolidin-1-yl)ethyl (meth)acrylate, and 2-(2-oxoimidazolidin-1-yl)ethyl methacrylate, and mixtures of these monomers, and
(c) 0.05 to 5 wt % of at least one ethylenically unsaturated, copolymerizable photoinitiator.

The glass transition temperature (Tg) of the polymer is less than or equal to 10° C., preferably in the range from −60 to +10° C., more particularly in the range from −60 to 0° C., or from −55° C. to −10° C., more preferably from −55° C. to −20° C. For radiation-crosslinkable polymers the glass transition temperature relates to the noncrosslinked polymers. The glass transition temperature can be determined by differential scanning calorimetory. The equation referred to as the Fox equation allows the skilled person to identify copolymers in the appropriate Tg range beforehand, and to prepare them specifically by appropriate variation in the nature and amount of the monomers. According to Fox (T. G. Fox, Bull, Am. Phys. Soc. 1956 [Ser, II] 1, page 123, and in accordance with Ullmann's Encyclopadie der technischen Chemie, vol 19, page 18, 4th edition, Verlag Chemie, Weinheim, 1980), the glass transition temperature of copolymers with no more than low levels of crosslinking is given in good approximation by:

1/T_{g}=x¹/T_{g}¹+x²/T_{g}²+ . . . +xⁿ/T_{g}ⁿ,

where x¹, x², . . . xⁿ are the mass fractions of the monomers 1, 2, . . . n and T_{g}¹, T_{g}², . . . T_{g}ⁿ are the glass transition temperatures of the polymers synthesized in each case only from one of the monomers 1, 2, . . . n, in degrees Kelvin. The T_{g} values for the homopolymers of the majority of monomers are known and are listed in, for example, Ullmann's Encyclopedia of Industrial Chemistry, vol A21, page 169, 5th edition, VCH Weinheim, 1992; further sources of homopolymer glass transition temperatures include, for example, J. Brandrup, E. H. Immergut, Polymer Handbook, 1st edition, J. Wiley, New York 1966, 2nd edition, J. Wiley, New York 1975, and 3rd edition, J. Wiley, New York 1989.

The polymer preferably has a K value of greater than or equal to 20, as for example of 30 to 80, more preferably of 40 to 60, as measured in tetrahydrofuran (1% strength solution, 21° C.). The K value according to Fikentscher is a measure of the molecular weight and the viscosity of the polymer. The viscosity here is measured using a capillary viscometer. Protocols are found in DIN EN 150 1628-1:2012-10.

In one embodiment the hotmelt adhesive further comprises at least one oligo(meth)acrylate, which has one or more nonacrylic, olefinic C—C double bonds.

In order to achieve a good viscosity-lowering effect in conjunction with, good cohesion, the weight ratio of poly(meth)acrylate to oligo(meth)acrylate is preferably in the range from 99:1 to 50:50, more preferably from 95:5 to 75:25. The oligo(meth)acrylates have one or more nonacrylic, olefinic C—C double bonds. They have a K value of less than or equal to 20, preferably of 10 to 20, as measured in tetrahydrofuran (1% strength solution, 21° C.)

The oligo(meth)acrylates are preferably composed to an extent of at least 40 wt %, more preferably at least 60 wt %, very preferably at least 80 wt %, of what are known as principal monomers. The principal monomers are selected from C1-C20 alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and 1 or 2 double bonds, or mixtures of these monomers. Examples include (meth)acrylic acid alkyl esters having a C1-C10 alkyl radical, such as methyl methacrylate, methyl acrylate, n-butyl acrylate, ethyl acrylate and 2-ethylhexyl acrylate. Also suitable in particular are mixtures of the (meth)acrylic acid alkyl esters. Vinyl esters of carboxylic acids having 1 to 20 C atoms are, for example, vinyl laurate, vinyl stearate, vinyl propionate. Versatic acid vinyl esters, and vinyl acetate. Vinylaromatic compounds contemplated include vinyltoluene, alpha- and p-methylstyrene, alpha-butylstyrene, 4-n-butylstyrene, 4-n-decylstyrene, and, preferably, styrene. Examples of nitriles are acrylonitrile and methacrylonitrile. The vinyl halides are ethylenically unsaturated compounds substituted by chlorine, fluorine or bromine, preferably vinyl chloride and vinylidene chloride. Examples of vinyl ethers include vinyl methyl ether or vinyl isobutyl ether. Preference is given to vinyl ethers of alcohols comprising 1 to 4 C atoms. Hydrocarbons having 2 to B C atoms and one or two olefinic double bonds include butadiene, isoprene, and chloroprene, ethylene or propylene. Preferred principal monomers are the C1 to C10 alkyl acrylates and methacrylates, more particularly C1 to C8 alkyl acrylates and methacrylates, with the acrylates being particularly preferred in each case. Especially preferred are methyl acrylate, ethyl acrylate, n-butyl acrylate, n-hexyl acrylate, octyl acrylate, and 2-ethylhexyl Std acrylate, and also mixtures of these monomers.

Besides the principal monomers, the oligo(meth)acrylates may comprise further monomers, examples being monomers having carboxylic acid, sulfonic acid or phosphonic acid groups. Carboxylic acid groups are preferred. Examples include acrylic acid, methacrylic acid, itaconic acid, maleic acid or fumaric acid. Further monomers are, for example, also monomers comprising hydroxyl groups, more particularly C1-C10 hydroxylalkyl (meth)acrylates, (meth)acrylamide, and monomers comprising ureido groups, such as ureido (meth)acrylates. As further monomers, mention may additionally be made of phenyloxyethylglycol mono(meth)acrylate, glycidyl acrylate, glycidyl methacrylate, and amino (meth)acrylates such as 2-aminoethyl (meth)acrylate. Also contemplated in particular are cyclic lactams such as N-vinylpyrrolidone or N-vinylcaprolactam.

The oligo(meth)acrylates are synthesized preferably to an extent of at least 40 wt %, more preferably at least 60 wt %, and very preferably at least 80 wt %, of C1 to C20 alkyl (meth)acrylates, more particularly the alkyl (meth)acrylates identified above.

A key feature of the oligo(meth)acrylate is that it comprises crosslinkable groups having nonacrylic, crosslinkable C—C double bonds (crosslinkable groups for short). Crosslinkable double bonds are more particularly those which are radically polymerizable with other double bonds (i.e., crosslinked by radical polymerization), or those which form radicals as a result of elimination of a hydrogen atom (i.e., crosslinked by reactions of these radicals). Crosslinkable groups contemplated include, for example, the allyl group, or cyclic hydrocarbon groups having at least one nonaromatic C—C double bond. In the case of the cyclic hydrocarbon group, the group more particularly is a dihydrodicyclopentadienyl group of the formula:

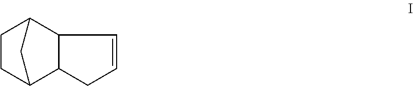

The crosslinkable group may be attached to the polymer in particular by copolymerization with monomers which comprise the crosslinkable group (crosslinkable monomers). Examples of suitable crosslinkable monomers include monomers which comprise a reactive ethylenically unsaturated group, necessary for the polymerization, and the above crosslinkable group. During the polymerization, the crosslinkable groups are at least partly conserved, since under the conditions of the polymerization it is first of all the more reactive ethylenically unsaturated group (e.g., an acrylic or methacrylic group) that undergoes polymerization. Monomers include allyl (meth)acrylate or monomers having a meth)acrylic group and a dihydrodicyclopentadienyl group. The (meth)acrylic group may be attached directly or indirectly (i.e., by an organic group as spacer) to the dihydrodicyclopentadienyl group; preference is given to dihydrodicyclopentadienyl (meth)acrylate of the formulae:

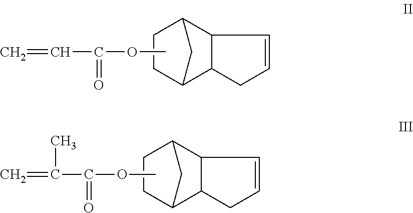

The oligo(meth)acrylate preferably has a crosslinkable groups content of 0.0001 to 0.5 mol/100 g of oligomer, or of 0.0002 to 0.1 or of 0.001 to 0.02 or of 0.003 to 0.01 mol/100 g of oligomer, more preferably of 0.005 to 0.25 mol/100 g of oligomer. The oligomer is preferably an oligomer which is crosslinkable by irradiation with high-energy light, e.g., UV light or electron beams. The oligomer is crosslinkable accordingly, for example, through above crosslinkable groups or else, if hydrogen atoms can be removed from the main polymer chain photochemically, including, in particular, with use of a photoinitiator or by means of electron beams, to form a radical which is able to enter into further chemical reactions. The oligomer may further comprise one of the above-described photoinitiators in copolymerized form.

The oligo(meth)acrylate preferably has a zero-shear viscosity at 23° C. of less than 5000 Pa s, preferably less than 3000 Pa s, more preferably less than 1000 Pa s.

The poly(meth)acrylates and the oligo(meth)acrylates can be prepared by copolymerizing the monomeric components, optionally including the copolymerizable photoinitiator, using the customary polymerization initiators and also, optionally, chain transfer agents (CTAs), with polymerization taking place at the customary temperatures in bulk, in emulsion, e.g., in water or liquid hydrocarbons, or in solution. The oligo(meth)acrylates are prepared in such a way as to ensure, by means of appropriate measures to limit the molecular weight, that their K value is less than or equal to 20.

The low molar masses are promoted particularly, for example, by the use of chain transfer agents or by the use of solvents that regulate the molecular weight, such as isopropanol or o-xylene. Polymerizations at temperatures above 100° C. and/or at low solids contents are also suitable. Alternatively it is also possible for oligo(meth)acrylates to be obtained by high-temperature bulk polymerization under pressure, as, is described in WO 03/066704. The poly(meth)acrylates and the oligo(meth)acrylates are preferably prepared either by emulsion polymerization in water or by polymerization of the monomers in organic solvents, more particularly in organic solvents with a boiling range of 50 to 150° C., preferably of 60 to 120° C., using the customary amounts of polymerization initiators, generally 0.01% to 10%, more particularly 0.1 to 4%, by weight, based on the overall weight of the monomers. The polymers can be prepared at temperatures of 20 to 150° C., preferably at temperatures in the range from 70 to 120° C., and at pressures of 0.1 to 100 bar (absolute), preferably at 0.3 to 10 bar, in the presence of 0.01% to 10% by weight of peroxides or azo initiators, as polymerization initiators, based on the monomers, and in the presence of 0% to 200% by weight of inert solvents, preferably 5% to 25% by weight, based on the monomers, i.e. by solution polymerization or bulk polymerization. The reaction takes place preferably within an increasing vacuum, as for example by lowering of the pressure from atmospheric pressure (1 bar) to 500 mbar (absolute). Solvents are, for example, hydrocarbons, alcohols such as methanol, ethanol, propanol, butanol, isobutanol, ketones such as acetone, methyl ethyl ketone, methyl isobutyl ketone, ethyl acetate, nitrites such as acetonitrile and benzonitrile, or mixtures of the solvents stated. In one preferred embodiment the solvents for the polymerization are one or more ketones having a boiling point of below 150° C. under atmospheric pressure (1 bar),

Examples of polymerization initiators contemplated include azo compounds, ketone peroxides, and alkyl peroxides, examples being acyl peroxides such as benzoyl peroxide, dilauroyl peroxide, didecanoyl peroxide, isononanoyl peroxide, alkyl esters such as tert-butyl perpivalate, tert-butyl per-2-ethythexanoate, tert-butyl permaleate, tert-butyl perisononanoate, tert-butyl perbenzoate, tert-amyl per-2-ethythexanoate, dialkyl peroxides such as dicumyl peroxide, tert-butyl cumyl peroxide, di-tert-butyl peroxide, and peroxodicarbonates. As initiators it is additionally possible for use to be made of azo initiators such as, for example, 2,2′-azobisisobutyronitrile, 2,2′-azobis(methyl isobutyrate) or 2,2-azobis(2,4-dimethylvaleronitrile).

For the conduct of the polymerization, particularly for preparing the oligomers, it is also possible for the reaction mixture to be admixed with what are called chain transfer agents, these being compounds which lower the degree of polymerization, which are added, for example, in amounts of 0.1 to 0.8 part by weight, based on 100 parts by weight of the monomers to be polymerized. Suitable examples include compounds having a thiol group, examples being mercaptans such as mercaptoethanol, tert-butyl mercaptan, mercaptosuccinic acid, ethylhexyl thioglycolate, 3-mercaptopropyltrimethoxysilane or dodecyl mercaptan.

Following the polymerization in solution, the solvents may optionally be separated off under reduced pressure, an operation which is conducted at elevated temperatures, as for example in the range from 100 to 150° C. The polymers can then be used in the solvent-free state (solvent content preferably less than 2 wt %, based on the overall composition), i.e., in the form of melts.

The hotmelt adhesive of the invention preferably has a zero-shear viscosity at 130° C. of less than 100 Pa s. It is used in solvent-free, meltable form. Solvent from the preparation process can be removed beforehand by suitable methods, preferably to a residual level of less than 0.5 wt %, based on the solids content.

The hotmelt adhesive may comprise the customary additives, of which representative examples include resins, plasticizers, antioxidants, crosslinkers, etc.

For producing the coatings, the hotmelt PSAs are applied as a melt to the materials that are to be coated, examples being substrates for adhesive tapes or labels, the surface being coated at least partly with an adhesive of the invention. The hotmelt PSA may be applied in the form of a melt, i.e., in general, at temperatures from 50 to 160° C., preferably 80 to 150° C., or greater than 100° C. The PSA application rate is preferably from 10 to 100 g/m², more preferably from 20 to 70 g/m². Coat thicknesses are, for example, 2 to 100 micrometers, preferably 10 to 80 or 20 to 70 micrometers.

Carriers contemplated include paper or polymer films, made of polyester, polyolefins, more particularly polyethylene or polypropylene, PVC, cellulose or polyacetate, for example.

Following application to the carriers, the radiation-crosslinkable hotmelt adhesive of the invention is irradiated with high-energy radiation, preferably UV light, more particularly UV-C radiation (200-280 nm), to produce crosslinking. For this purpose, generally speaking, the coated substrates are placed on a conveyor belt and the belt is conveyed past a radiation source, such as a UV lamp. The degree of crosslinking of the polymers is dependent on the duration and intensity of the irradiation. The radiation energy preferably totals 100 to 1500 mJ/cm² of irradiated surface area. As UV sources it is possible to use the customary sources, examples being medium-pressure mercury lamps with a radiation output of 80 to 240 watts/cm.

For producing pressure-sensitive adhesive labels, the PSA may for example also be applied by transfer application to carriers such as paper or polymer films, by first being applied to adhesively coated carrier materials, such as siliconized paper, and irradiated, and then laminated, for example, onto paper. Following the removal of the siliconized paper, the pressure-sensitively adhesive layer may optionally be irradiated again. The pressure-sensitive adhesive materials can be converted and/or modified in a form which is customary per se.

In this way it is possible to produce adhesive articles, especially adhesive articles having pressure-sensitively adhesive properties. The hotmelt adhesive of the invention is a material which, particularly after crosslinking by irradiation, has pressure-sensitive adhesive properties. A PSA (pressure-sensitive adhesive) is a viscoelastic adhesive whose set film at room temperature (20° C.) in the dry state remains permanently tacky and adhesive.

Preferred adhesive articles are adhesive labels, adhesive tapes, and self-adhesive films. Adhesive tapes are particularly preferred. The invention therefore also provides adhesive tapes which on one or both sides of a tapelike carrier material have a coating comprising a radiation-crosslinked hotmelt adhesive of the invention. The carrier material in this case is preferably selected from polyethylene, polypropylene, cellulose, polyacetate, and polyester.

The invention also provides the use of the poly(meth)acrylate for producing adhesives, preferably as pressure-sensitive adhesive for producing adhesive labels, adhesive tapes, plasters, bandages, and self-adhesive sheets.

The invention also provides pressure-sensitive adhesive articles where at least part of a substrate surface has been coated with at least one above-described pressure-sensitive hotmelt adhesive.

A feature of the adhesives of the invention is that at room temperature they exhibit particularly high shear strengths on steel and nevertheless still exhibit good peel strengths on steel.

### EXAMPLES

Substances used:

PEMA 2-(2-oxopyrrolidin-1-yl)ethyl methacrylate

PEA 2-(2-oxopyrrolidin-1-yl)ethyl acrylate

Heonone acrylate 2-(2-oxooxazolidin-3-yl)ethyl acrylate

UMA 2-(2-oxoimidazoidin-1-yl)ethyl methacrylate (ureido methacrylate)

MEK methyl ethyl ketone

FI—photoinitiator monomer:

Polymerizable photoinitiator (35% strength solution in MEK) of the formula F-1, with R1 being a C4 chain, R2 being hydrogen, and R3 being a phenyl group.

### Example 1 with PEMA

A polymerization apparatus consisting of glass reactor, reflux condenser, stirrer, and nitrogen inlet is charged under a gentle nitrogen stream with 215 g of MEK, and this initial charge is heated to 80° C. 51.1 g are added of a monomer mixture consisting of 745 g of n-butyl acrylate, 212 g of PEMA, 14.3 g of photoinitiator monomer FI (35% strength in MEK), and 50 g of acrylic acid. When 80° C. are regained, 9.4 g of an initiator solution comprising 26.6 g of tert-butyl perpivalate (75% strength in mineral oil) and 161.1 g of MEK are added, and initial polymerization takes place for 3 minutes. Then the remaining 970.9 g of monomer mixture and 178.4 g of initiator solution are run in over 3 hours. The temperature is subsequently raised to 90° C. and a solution of 3.2 g of tert-butyl perpivalate (75% strength in mineral oil) in 24.4 g of MEK is added over 30 minutes. Reduced pressure is applied thereafter, and the solvent is distilled off at a maximum of 135° C. and less than 50 mbar. This is followed, still with slow stirring, by degassing under optimum reduced pressure at 135° C. for 1 hour. The melt is discharged into a PP beaker.

K value (1% in THF): 43

Zero-shear viscosity at 130° C.: 89 Pa s,

### Example 2 with PEA

A polymerization apparatus consisting of glass reactor, reflux condenser, stirrer, and nitrogen inlet is charged under a gentle nitrogen stream with 70 g of MEK, and this initial charge is heated to 80° C. 35.5 g are added of a monomer mixture consisting of 521 g of n-butyl acrylate, 140 g of PEA, 10 g of photoinitiator monomer FI (35% strength in MEK), and 35 g of acrylic acid. When 80° C. are regained, 6 g of an initiator solution comprising 7.5 g of tert-butyl perpivalate (75% strength in mineral oil) and 112.7 g of MEK are added, and initial polymerization takes place for 3 minutes. Then the remaining 671.2 g of monomer mixture and 114.2 g of initiator solution are run in over 3 hours. The temperature is subsequently raised to 90° C. and a solution of 2.24 g of tert-butyl perpivalate (75% strength in mineral oil) in 17 g of MEK is added over 30 minutes. Reduced pressure is applied thereafter, and the solvent is distilled off at a maximum of 135° C. and less than 50 mbar. This is followed, still with slow stirring, by degassing under optimum reduced pressure at 135° C. for 1 hour. The melt is discharged into a PP beaker.

K value (1% in THF): 41

Zero-shear viscosity at 130° C.: 55 Pa s,

### Example 3 with Heonone Acrylate

A polymerization apparatus consisting of glass reactor, reflux condenser, stirrer, and nitrogen inlet is charged under a gentle nitrogen stream with 215 g of MEK, and this initial charge is heated to 80° C. 50.28 g are added of a monomer mixture consisting of 747 g of 2-ethylhexyl acrylate, 200 g of Heonone acrylate, 8.57 g of photoinitiator monomer FI (35% strength in MEK), and 50 g of acrylic acid. When 80° C. are regained, 8.39 g of an initiator solution comprising 6.67 g of tert-butyl perpivalate (75% strength in mineral oil) and 161.1 g of MEK are added, and initial polymerization takes place for 3 minutes. Then the remaining 955.3 g of monomer mixture and 159.4 g of initiator solution are run in over 3 hours. The temperature is subsequently raised to 90° C. and a solution of 3.2 g of tert-butyl perpivalate (75% strength in mineral oil) in 24.4 g of MEK is added over 30 minutes. Reduced pressure is applied thereafter, and the solvent is distilled off at a maximum of 135° C. and less than 50 mbar. This is followed, still with slow stirring, by degassing under optimum reduced pressure at 135° C. for 1 hour. The melt is discharged into a PP beaker.

K value (1% in THF): 49.1

Zero-shear viscosity at 130° C.: 83.3 Pa s,

### Example 4 with UMA

A polymerization apparatus consisting of glass reactor, reflux condenser, stirrer, and nitrogen inlet is charged under a gentle nitrogen stream with 371 g of MEK, and this initial charge is heated to 80° C. 40.4 g are added of a monomer mixture consisting of 556 g of 2-ethylhexyl acrylate, 200 g of UMA (40% strength in 2-ethylhexyl acrylate), 11.43 g of photoinitiator monomer FI (35% strength in MEK), and 40 g of acrylic acid. When 80° C. are regained, 7.91 g of an initiator solution comprising 18.3 g of tert-butyl perpivalate (75% strength in mineral oil) and 140 g of MEK are added, and initial polymerization takes place for 3 minutes. Then the remaining 767 g of monomer mixture and 150.2 g of initiator solution are run in over 3 hours. The temperature is subsequently raised to 90° C. and a solution of 2.6 g of tert-butyl perpivalate (75% strength in mineral oil) in 19.5 g of MEK is added over 30 minutes. Reduced pressure is applied thereafter, and the solvent is distilled off at a maximum of 135° C. and less than 50 mbar. This is followed, still with slow stirring, by degassing under optimum reduced pressure at 135° C. for 1 hour. The melt is discharged into a PP beaker.

K value (1% in THF): 30.2

Zero-shear viscosity at 130° C.: 33.4 Pa s,

### Example 5: Morpholinoethyl Acrylate (Comparative Example)

A polymerization apparatus consisting of glass reactor, reflux condenser, stirrer, and nitrogen inlet is charged under a gentle nitrogen stream with 200 g of MEK, and this initial charge is heated to 80° C. 50.5 g are added of a monomer mixture consisting of 745 g of n-butyl acrylate, 200 g of morpholinoethyl acrylate, 14.3 g of photoinitiator monomer Ft 1484 (35% strength in MEK), and 50 g of acrylic acid. When 80° C. are regained, 2.24 g of an initiator solution comprising 1.87 g of tert-butyl perpivalate (75% strength in mineral oil) and 42.9 g of MEK are added, and initial polymerization takes place for 3 minutes. Then the remaining 958.8 g of monomer mixture and 42.5 g of initiator solution are run in over 3 hours. The temperature is subsequently raised to 90° C. and a solution of 3.2 g of tert-butyl perpivalate (75% strength in mineral oil) in 24.4 g of MEK is added over 30 minutes. Reduced pressure is applied thereafter, and the solvent is distilled off at a maximum of 135° C. and less than 50 mbar. This is followed, still with slow stirring, by degassing under optimum reduced pressure at 135° C. for 1 hour. The melt is discharged into a PP beaker.

K value (1% in THF): 39

Zero-shear viscosity at 130° C.: 44 Pa s,

Measurement of the Zero-Shear Viscosity

The zero-shear viscosity is the limiting value of the viscosity function at infinitely low shear rates. It is measured using an Anton Paar MCR 100 Rheometer (US 200 evaluation software) in plate/plate geometry. The samples are measured in oscillatory shear at a low shearing amplitude of 10%. Temperature is 130° C. (or as specified), circular frequency ramp log 100-0.1 1/s, measuring slot 0.5 mm, evaluation by Carreau-Gahleitner I, die diameter 25 mm.

Performance Tests:

The pressure-sensitive adhesives (PSAs) were knife-coated at an application rate of 60 g/m² onto siliconized PET film and irradiated with UVC light. The applied film is then transferred to a Hostaphan® RN 36 PET film carrier. The PSA-coated carrier was slit into test strips 25 mm wide.

a) Peel Strength (Adhesion)

For the determination of the peel strength, the test strips 25 mm wide were adhered to the test surface of steel (AFERA steel) or polyethylene and rolled on once using a roller weighing 1 kg. The test strips were clamped by one end into the upper jaws of a tension-elongation testing apparatus. The adhesive strip was peeled off from the test surface at a 180° angle and at 300 mm/min—that is, the adhesive strip was bent around and peeled off parallel to the metal test plate, and the force required to achieve this was recorded. The measure of the peel strength is the force in N/25 mm which results as the average value from five measurements. The peel strength was determined 24 hours after bonding. After this time, the bond strength has developed fully.

b) Shear Strength (Cohesion)

For the determination of the shear strength, the test strips were adhered with a bonded area of 12.5×12.5 mm to steel plate (AFERA steel), rolled on once using a roller weighing 1 kg, and then loaded in suspension with a 1 kg weight. The shear strength (cohesion) was determined under standard conditions (23° C.; 50% relative humidity) and at 70° C. The measure of the shear strength is the time in hours taken for the weight to fall off. The average was formed from five measurements in each case.

c) S.A.F.T. Test (Thermal Stability)

The test strips were adhered with a bonded area of 25×25 mm to AFERA steel, rolled on 4 times using a roller weighing 2 kg, and, after a contact time of at least 16 hours, loaded in suspension with a 1 kg weight. During the loading phase, heating took place continuously, starting from 23° C., at a rate of 0.5° C./min. The heating temperature attained when the weight falls off is a measure of the thermal stability of the adhesive. The average was calculated from three measurements in each case.

The results are summarized in Table 1.

TABLE 1
Results of the performance tests

| | | Peel strength | | Shear | |
|---|---|---|---|---|---|
| | Dose¹⁾ | [N/25 mm] | | strength, | S.A.F.T. test |
| Ex. | [mJ/cm²] | 24 h steel | 24 h PE | steel [h] | [° C.] |
| 1 | 10 | 31.6 | 4 | 16 | |
| 1 | 25 | 32.2 | 9 | 443 | 94 |
| 1 | 65 | 20.8 | 9.7 | 512 | 100 |
| 3 | 25 | 26.8 | 5.5 | 255 | |
| 3 | 65 | 25.1 | 6.0 | 202 | |
| 5 | 65 | 22.5 | 7.5 | 41 | |
| comparative | | | | | |

¹⁾UV-C radiation dose

The results show that the shear strength measured over a small area shows a high value and the peel strength on steel is above 20 N/125 mm even with a high irradiation dose.

1: A hotmelt adhesive, comprising at least one poly(meth)acrylate which is formed from
(a) at least one monomer M1, which is a C1 to C18 alkyl (meth)acrylate,
(b) at least one monomer M2 of formula 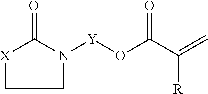
where X is O, NH or CH₂, Y is a divalent organic connecting group, and R is H or methyl,
and optionally further monomers different from the monomers M1 and M2.

2: The hotmelt adhesive according to claim 1, wherein the poly(meth)acrylate is formed from
(a) at least 50 wt % of the monomers M1, based on a total weight of all monomers, and
(b) at least 0.1 wt % of the monomers M2, based on the total weight of all monomers,
wherein the poly(meth)acrylate has a glass transition temperature of less than or equal to 10° C.

3: The hotmelt adhesive according to claim 1, wherein Y is a linear alkylene group having 2 to 6 C atoms.

4: The hotmelt adhesive according to claim 1, wherein the monomer M2 is at least one selected from the group consisting of 2-(2-oxooxazolidin-3-yl)ethyl acrylate, 2-(2-oxopyrrolidin-1-yl)ethyl acrylate, 2-(2-oxoimidazolidin-1-yl)ethyl acrylate, 2-(2-oxooxazolidin-3-yl)ethyl methacrylate, 2-(2-oxopyrrolidin-1-yl)ethyl methacrylate, and 2-(2-oxoimidazolidin-1-yl)ethyl methacrylate.

5: The hotmelt adhesive according to claim 1, wherein the poly(meth)acrylate is radiation-crosslinkable, the hotmelt adhesive further comprises at least one photoinitiator as an additive, the photoinitiator is not bonded to the poly(meth)acrylate and/or the photoinitiator is not incorporated into the poly(meth)acrylate by copolymerization, and the radiation-crosslinkable poly(meth)acrylate has a glass transition temperature before crosslinking of less than or equal to 10° C.

6: The hotmelt adhesive according to claim 1, wherein the poly(meth)acrylate has a K value of at least 20.

7: The hotmelt adhesive according to claim 1, wherein the poly(meth)acrylate is formed from at least 50 wt % of C4 to C10 alkyl (meth)acrylates.

8: The hotmelt adhesive according to claim 5, wherein the radiation-crosslinkable poly(meth)acrylate is crosslinkable by irradiation with UV light.

9: The hotmelt adhesive according to claim 5, wherein the photoinitiator is copolymerized into the poly(meth)acrylate in a form of an ethylenically unsaturated, copolymerizable photoinitiator in an amount of 0.05 to 5 wt %.

10: The hotmelt adhesive according to claim 5, wherein the photoinitiator is in an uncopolymerized form and has a structure of
A-X—B, where
A is a monovalent organic radical which has a phenone group,
X is an ester group of —O—C(═O)—, —(C═O)—O, or —O—(C═O)—O—,
and B is a monovalent organic radical which comprises an ethylenically unsaturated, radically polymerizable group.

11: The hotmelt adhesive according to claim 10, wherein the photoinitiator has a structure of 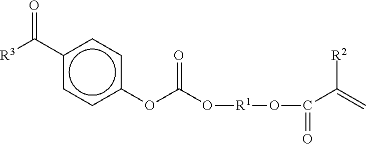
in which R1 is a divalent organic radical having up to 30 C atoms, R2 is an H atom or a methyl group, and R3 is a substituted or unsubstituted phenyl group or is a C1-C4 alkyl group.

12: The hotmelt adhesive according to claim 1, wherein the poly(meth)acrylate is formed, additionally to the C1 to C18 alkyl (meth)acrylates, from at least one monomer having polar groups, the polar group is at least one selected from the group consisting of a carboxylic acid group, a carboxylic anhydride group, a hydroxyl group, an amide group, urethane group, a urea group, a piperidyl group, a piperazinyl group, a morpholinyl group, and an imidazoyl group.

13: The hotmelt adhesive according to claim 12, wherein the poly(meth)acrylate polymer is formed from 0.1 to 30 wt % of the at least one monomer having polar groups.

14: The hotmelt adhesive adhesion according to claim 1, wherein the poly(meth)acrylate is formed from
(a1) at least 60 wt % of the at least one monomer M1 which is selected from the group consisting of n-butyl acrylate, n-hexyl acrylate, 2-ethylhexyl acrylate, propylheptyl acrylate, and a mixture thereof, and
(a2) 0.5 to 15 wt % of monomers having polar groups, the polar groups being carboxylic acid groups,
(b) 0.2 to 25 wt % of monomers M2, selected from the group consisting of 2-(2-oxooxazolidin-3-yl)ethyl (meth)acrylate, 2-(2-oxopyrrolidin-1-yl)ethyl (meth)acrylate, and 2-(2-oxoimidazolidin-1-yl)ethyl methacrylate, and a mixture thereof, and
(c) 0.05 to 5 wt % of at least one ethylenically unsaturated, copolymerizable photoinitiator.

15: A poly(meth)acrylate for the hotmelt adhesive according to claim 3, the poly(meth)acrylate being formed from
(a) the at least one monomer M1,
(b) the at least one monomer M2 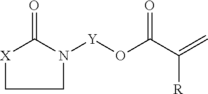
and at least one photoinitiator copolymerized into the poly(meth)acrylate.

16: The poly(meth)acrylate according to claim 15, wherein the poly(meth)acrylate is formed from
(a1) at least 60 wt % oft 1 at least one monomer M1 which is selected from the group consisting of n-butyl acrylate, n-hexyl acrylate, 2-ethylhexyl acrylate, propylheptyl acrylate, and a mixture thereof,
(a2) 0.5 to 15 wt % of monomers having polar groups, the polar groups being carboxylic acid groups,
(b) 0.2 to 25 wt % of the at least one monomer M2 selected from the group consisting of 2-(2-oxooxazolidin-3-yl)ethyl (meth)acrylate, 2-(2-oxopyrrolidin-1-yl)ethyl (meth)acrylate, and 2-(2-oxoimidazolidin-1-yl)ethyl methacrylate, and a mixture thereof, and
(c) 0.05 to 5 wt % of at least one ethylenically unsaturated, copolymerizable photoinitiator.

17: A method for producing an adhesive, the method comprising: incorporating the poly(meth)acrylate according to claim 15 into the adhesive.

18: A pressure-sensitive adhesive article, which has at least a part of a substrate surface coated with at least one hotmelt adhesive according to claim 1.
